(19) United States
(12) Patent Application Publication
(10) Pub. No.: US 2025/0283518 A1
(43) Pub. Date: Sep. 11, 2025

(54) VIBRATION ISOLATION MOUNT

(71) Applicant: Pliteq Inc., Toronto (CA)

(72) Inventors: Paul Charles DOWNEY, Toronto (CA); Wilson BYRICK, Toronto (CA)

(73) Assignee: Pliteq Inc., Toronto, ON (CA)

(21) Appl. No.: 18/596,167

(22) Filed: Mar. 5, 2024

(51) Int. Cl. F16F 3/087

(52) U.S. Cl. CPC F16F 3/0876; F16F 2224/025; F16F 2232/08; F16F 2234/02; F16F 2236/045

(57) ABSTRACT

An isolation mount for reducing transmission of vibrations between surfaces and equipment. The isolation mount includes a housing and one or more crumb rubber isolators. The housing includes a rigid body and a flange. The one or more crumb rubber isolators have through holes for receiving the fastener.

### TECHNICAL FIELD

The present application relates to isolation mounts, and more particularly, to isolation mounts for performing vibration and seismic isolation.

### BACKGROUND

HVAC systems, machinery, industrial equipment, structures, and components thereof, may be damaged due to vibration, shock, and noise leading to costly repairs and replacement. Further, such equipment may transmit vibrations, shock and noise to the structure of a building which may cause a nuisance in other portions of the building. Generally, isolation mounts have been developed to reduce transmission of vibration, shock, and noise to and from systems, structures, and their components. Isolation mounts are ordinarily constructed of a metal housing and neoprene rubber as the isolation material. They allow equipment to resist compression, tension, and shear forces due to seismic, wind, and other extreme events. While isolation mounts made of neoprene rubber are suitable material for vibration isolation, they traditionally operate over narrow load ranges.

### DESCRIPTION OF THE DRAWINGS

Reference will now be made, by way of example, to the accompanying drawings which show example embodiments of the present invention. In the drawings:

FIG. 1 illustrates an exploded perspective view of an example of an isolation mount.

FIG. 2 illustrates a cross-sectional view of a housing of the isolation mount in FIG. 1.

FIG. 3 illustrates a perspective view of an isolator in FIG. 1.

FIG. 4 illustrates a fastener in FIG. 1.

FIG. 5 illustrates a bottom washer in FIG. 1.

FIG. 6 illustrates a top washer in FIG. 1.

FIG. 7 illustrates a method of installation of the isolation mount in FIG. 1.

Similar reference numerals may have been used in different figures to denote similar components.

### DESCRIPTION OF EXAMPLE EMBODIMENTS

In one aspect, the present application describes an isolation mount for reducing transmission of vibrations between a first surface and a second surface. The isolation mount includes a housing. The housing includes a rigid body. The rigid body may define a hole for receiving a fastener to couple the rigid body to the first surface. The housing may include a flange connected to the rigid body. The flange is for coupling the isolation mount to the first surface. The isolation mount may further include one or more crumb rubber isolators having through holes for receiving the fastener.

In some implementations, the isolation mount may include the fastener for coupling the isolation mount to the first surface.

In some implementations, the rigid body may define at least one internal cavity. The one or more crumb rubber isolators may be situated, at least in part, in at least one of the internal cavities.

In some implementations, the crumb rubber isolators may be constructed of rebound crumb rubber.

In some implementations, the crumb rubber isolators may be constructed of recycled rebound crumb rubber.

In some implementations, the crumb rubber isolators may be constructed of soft crumb rubber.

In some implementations, the crumb rubber isolators may be constructed of at least 94% recycled rubber content.

In some implementations, the flange may be triangularly shaped with a plurality of holes configured to allow the flange to be secured to the first surface.

In some implementations, the isolation mount may further include a top washer disposed on a top surface of a top isolator of the one or more crumb rubber isolators.

In some implementations, the isolation mount may further include a bottom washer disposed on a bottom surface of a bottom isolator of the one or more crumb rubber isolators.

In some implementations, the bottom washer may include at least one protrusion to grip the bottom isolator.

In some implementations, the fastener may be a bolt. The bolt may include a threaded shank between a first end and a second end. The first end may have a head that interlocks with the bottom washer to prevent relative rotational movement between the bolt and the bottom washer.

In some implementations, the body of the housing may have a substantially circumferential wall. The body of the housing may also have an inner flange extending from the interior side of the circumferential wall.

In some implementations, the inner flange may be placed between the one or more crumb rubbers isolators.

In some implementations, the housing may include a threaded shaft running along a center of the housing. The one or more crumb rubber isolators may support the threaded shaft. The threaded shaft may be configured to receive the fastener.

In some implementations, an inner circumferential edge of the inner flange may be connected to the exterior wall of the threaded shaft.

In some implementations, the one or more crumb rubber isolators are cylindrically shaped.

In some implementations, the one or more crumb rubber isolators may be adjacent to an interior wall of the rigid body of the housing.

In another aspect, an isolation mount assembly for reducing transmission vibrations is described. The isolation mount includes a first surface, a second surface and an isolation mount. The isolation mount, includes a fastener for coupling the isolation mount to the second surface. The isolation mount includes a housing. The housing includes a rigid body defining a hole for receiving the fastener. The housing includes a flange connected to the rigid body. the flange for coupling the isolation mount to the first surface. The isolation mount further includes one or more crumb rubber isolators having through holes for receiving the fastener.

In another aspect, a method of installation of an isolation mount described herein is described. The method may include: positioning the flange of the isolation mount on a first surface; securing the flange to the first surface using at least one base fastener; aligning the second surface to the top end of the housing; and securing the isolation mount to a second surface using the fastener of the isolation mount.

Other aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

The present disclosure relates to an isolation mount for reducing transmission of vibrations. In particular, it is an improvement on restrained isolation mounts. Generally, isolation mounts are constructed of neoprene rubber for the isolation material and metal for the housing. Isolation mounts assist equipment by resisting compression, tension, and shear due to seismic, wind, and other extreme events.

Generally, the isolation material of known isolation mounts is constructed of neoprene rubber. While it is suitable material for vibration isolation, it only works over a narrow load range. For example, the Mason BR Mount™ is offered in five different sizes, and each of those sizes may have four different durometers of rubber. Accordingly, the Mason BR Mounts™ are designed for a small load range, especially at low loads. For example, there are five different versions of an isolation mount from 30 lbs to 125 lbs.

In at least some implementations, the present disclosure describes an isolation mount that uses crumb rubber as an isolating material, particularly, recycled rebounded crumb rubber, which offers a wider load range compared to isolation mounts constructed of neoprene rubber. At least some mounts constructed described herein may support a load range from 25 lbs to 1000 lbs. Conveniently, in this way users may spend less time and resources selecting isolation mounts for new projects and the same isolation mount may be used for projects of varying types.

Crumb rubber is a form of recycled rubber. Crumb rubber is generated from various sources, such as, shredding waste tires, rubber products, and industrial rubber waste. Crumb rubber has many beneficial properties with respect to its flexibility, resilience, and durability. Further, crumb rubber promotes recycling and providing an eco-friendly solution for repurposing rubber waste. By utilizing crumb rubber, valuable resources are conserved, and the environmental impact of rubber waste disposal may be reduced.

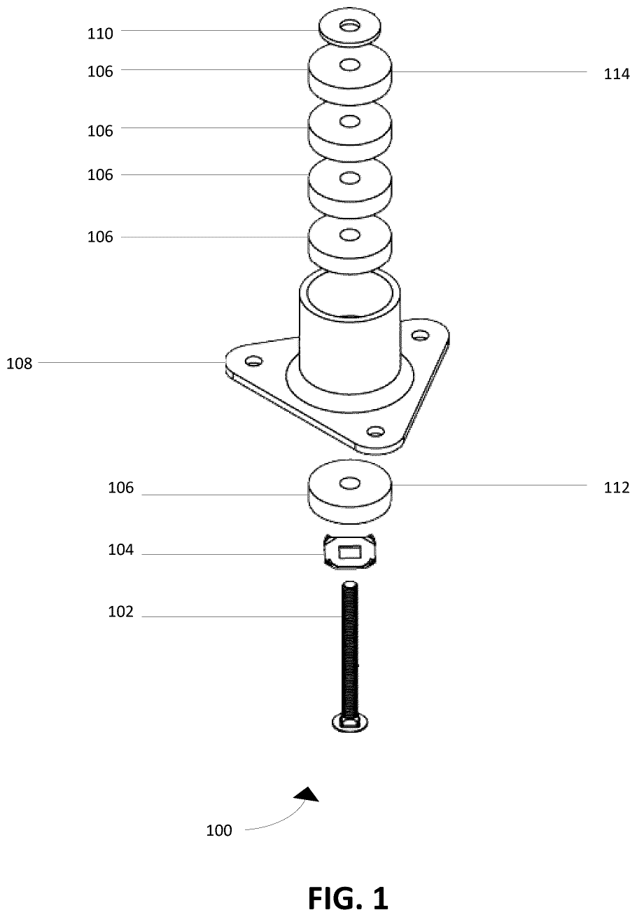

FIG. 1 illustrates an exploded perspective view of an example of an isolation mount 100. The isolation mount 100 may include a fastener 102. The fastener 102 may operate to fix other components of the isolation mount together 100. For example, the fastener may fix one or more of a bottom washer 104, one or more crumb rubber isolators 106, a housing 108, and a top washer 110 together. The fastener 102 may, in at least some implementations, couple or fasten the isolation mount 100 to a surface, which may be referred to herein as a second surface.

In the illustrated example, the fastener 102 includes a bolt and a nut. In some implementations, the isolation mount may include further or alternative fasteners or fastening components, such as screws, washers, rivets, adhesives, and nails.

In some cases, the isolation mount 100 may be coupled to both a first surface and a second surface. The first surface may be associated with a first object and the second surface may be associated with a second object. For example, the first object may be a building or other structure. For example, the first surface may be associated with a floor, wall or ceiling. The second object may be or include a vibration source. For example, the vibration source may be any one or more or a combination of electronic equipment, machinery and industrial equipment, HVAC systems, etc.

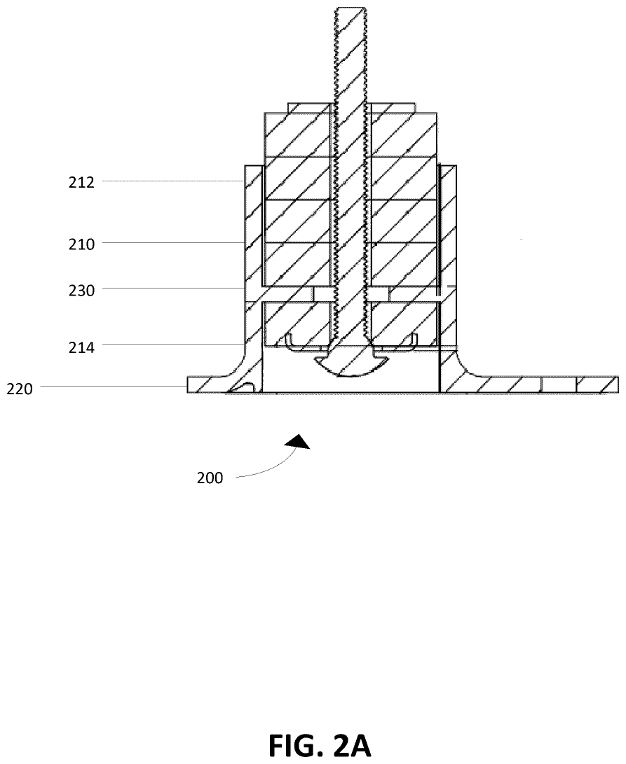

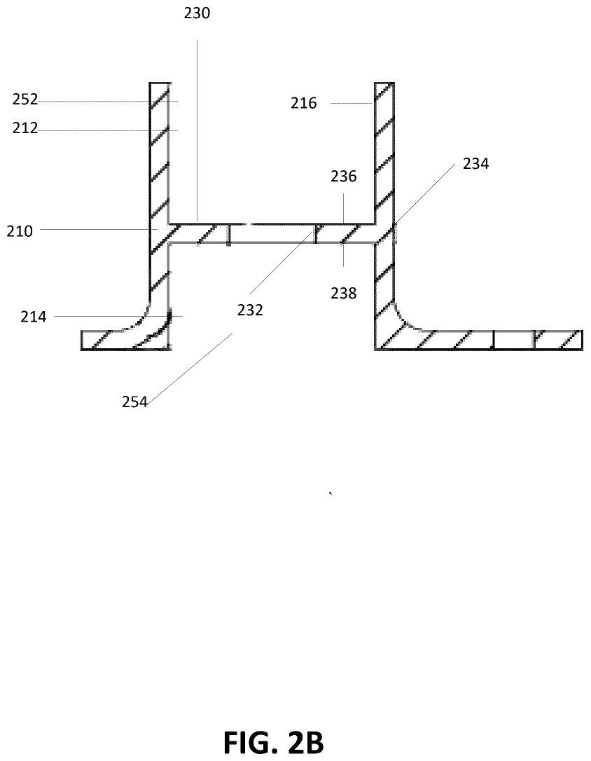

The isolation mount 100 may be coupled to the first surface using one or more fasteners, which may be referred to as base fasteners. In some cases, a housing 108 of the isolation mount 100 may be fastened to the first surface. For example, a flange 220 (FIG. 2) of the housing 108 may be fastened to the first surface. The flange 220 (FIG. 2) may include one or more fastening features which facilitate such fastening. The fastening features may be or include holes or other voids that receive the base fastener(s). The base fasteners may be or include any one or more of: bolts, nuts, screws, washers, rivets, adhesives, and nails.

The isolation mount 100 includes one or more crumb rubber isolators 106. The one or more crumb rubber isolators 106 may be separated into two groups or portions. For example, a portion of the rigid body 210 (FIG. 2) of the housing 108, such as the inner flange 230, may act as a divider or separator. The divider or separator physically separates one or more of the crumb rubber isolators 106 from another one or more of the crumb rubber isolators. In this case, the one or more crumb rubber isolators 106 include a bottom crumb rubber isolator 112 and a plurality of top crumb rubber isolators 114. In some cases, there may be a plurality of bottom crumb rubber isolators. In some cases, there may only be one top crumb rubber isolator.

“Bottom” and “top” as used herein are used to refer to orientations when the isolation mount 100 is floor mounted. Put differently, the term “bottom” is used to refer to the portion of the isolation mount 100 that is mounted to the first surface and the term “top” is used to refer to the portion of the isolation mount 100 that is mounted to the second surface. The terms “bottom” and “top” may be replaced with “first side” and “second side” respectively.

The fastener 102 may pass through one or more components of the isolation mount 100. For example, the fastener may pass through any one or a combination of: a bottom washer 104, the bottom crumb rubber isolator 112, the housing 108, one or more top crumb rubber isolators 114 and a top washer 110. The fastener 102 may pass centrally through one or more such components. For example, each such component may define a hole or other void therethrough that allows the fastener 102 to pass through. By way of example, the crumb rubber isolators 106 may be ring-shaped. The crumb rubber isolators 106 may, in at least some implementations, define a hole that is sized to receive the fastener 102 or a portion thereof. In some implementations, the crumb rubber isolators 106 may define holes each having a diameter that is no more than three millimeters larger than the diameter of the bolt or other fastener that passes through them. In some implementations, the crumb rubber isolators 106 may define holes having a diameter that is no more than one millimeter larger than the diameter of the bolt or other fastener that passes through them.

The fastener 102 may be substantially centrally displaced through the center of the housing 108. The fastener 102 may be substantially axially displaced in the housing 108.

The fastener 102 may enter or be inserted from the bottom of the housing 108 (i.e., at a first side associated with the first surface) and exit or otherwise extend through the top of the housing 108 (i.e. at a second side associated with the second surface). In some cases, an end of the fastener 102, such as the top of the fastener 102, protrudes from the housing 108. The top of the fastener may be in contact with a second surface of an object, such as, a vibration source. In at least some implementations, the top of the fastener 102 may pass through a hole or other void in the second surface. In this way, the second surface may receive the fastener 102. This may allow the fastener 102 to couple the isolation mount 100 to the second surface. In some implementations, the fastener 102 may include a nut and bolt and the nut may be fastened to the bolt at a side of the second surface that is opposite the side at which the isolation mount is situated in order to couple the isolation mount 100 to the second surface.

The isolation mount may be used or installed in any orientation, i.e., under compression, tension, and/or shear. In some implementations, the isolation mounts may be installed to a first surface, such as the floor, wall, or ceiling by bolted installation, adhesive installation, welded installation, press-fit installation, suspended installation, or customized installation.

In some cases, the load range of the isolation mount may be approximately between 25 lbs to 1000 lbs. In some cases, a height of the isolation mount 100 excluding the bolt 102 may be approximately between 3 and 4 inches.

In some cases, the isolation mount prevents vibration and/or noise from permeating, transferring, and/or passing from a first surface to a second surface. The isolation mount is installed on a first surface using the flange of the isolation mount. The second surface may be connected to the isolation mount by an end of the fastener. One or more crumb rubber isolators may absorb the vibrations that passes through the isolation mount.

In some cases, the sources of the vibration include one or more of the following: machinery, HVAC systems, industrial equipment, electronic equipment, construction, and appliances.

FIG. 2 illustrates a front cross-sectional view of an example of a housing 200 from FIG. 1. The housing 200 may be constructed of a rigid material, such as metal. The housing includes the rigid body 210 and the flange 220. The rigid body 210 defines a through hole for receiving a fastener to couple the rigid body to the first surface. In some cases, the rigid body 210 may be cylindrically shaped and has a central axis. In some cases, the rigid body 210 may be of any shape to secure isolation material. The rigid body 210 may have one or both of a first open end 214 and a second open end 212. The first open end 214 may be coupled to the flange 220. Put differently, the first open end may be near a first surface; i.e., at a bottom end. The second open end 212 may be near a second surface; i.e., at a top end.

The housing 200 may further include an inner flange 230 disposed within the interior of the housing 200. The housing may also be referred to as a frame in at least some implementations.

The inner flange 230 may extend from the interior side wall 216 of the rigid body. In other words, the inner flange 230 may extend from the interior side wall 216 towards the center of the housing 200. In at least some implementations, the inner flange 230 may extend orthogonally from the interior side wall 216 towards the center of the housing 200. In some cases, the inner flange 230 is located closer to the first open end 214 of the rigid body 210 than to the second open end 212. In some cases, the inner flange 230 has an aperture, hole or other feature having a diameter corresponding to the diameter of the fastener 102. For example, the inner flange 230 may define a hole with substantially the same diameter as the fastener 102.

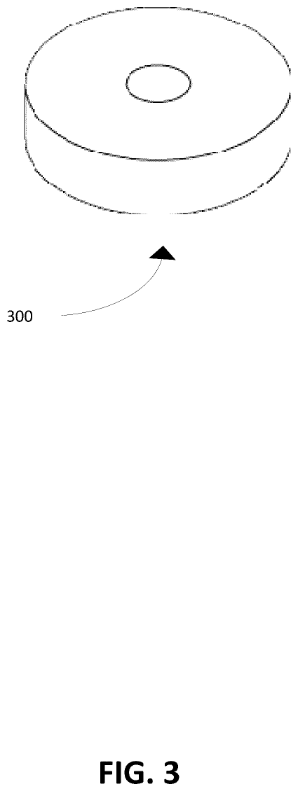

Referring to FIG. 3, the inner flange 230 may have an inner edge 232, an outer edge 234, and a flat body with an upper surface 236 and a lower surface 238, therebetween. The inner edge 232 is a sidewall of the hole or other aperture that receives the fastener 102. In some cases, the inner edge 232 may be threaded, and adjacent to, or in contact with the fastener 102 (FIG. 1). The upper surface 236 may be adjacent to a surface of an isolator of the plurality of isolators. The bottom surface 238 may be adjacent to a surface of a second isolator of the plurality of isolators. In other words, the inner flange 230 divides, separates, slots or is placed between, the plurality of isolators to secure the first surface and the second surface. For example, when the fastener 102 is fastened or tightened, the inner flange 230 secures the housing 200 to the fastener 102, the plurality of isolators, and by extension, the second surface. Without the inner flange 230, the fastener, the plurality of crumb rubber isolators may become easily detached from the housing 200 when a vertical force is applied. In other words, the first object may become detached from the second object due to vibration or seismic forces.

The housing 200 may further include a threaded shaft (not shown) extending along the central axis of the housing 200 configured to receive a fastener. The threaded shaft may be cylindrically shaped. The exterior wall of the threaded shaft may be coupled to the inner edge 232 of the inner flange 230 in the perpendicular direction. In some cases, the threaded shaft may provide more rigidity to the housing 200 to withstand lateral forces.

In some cases, the housing 200 may be constructed of metal, such as, aluminum or steel. In some cases, a powder coat may be applied on the housing 200.

The rigid body 210 of the housing 200 may define at least one internal cavity. One or more of the crumb rubber isolators may be situated, at least in part, in at least one of the internal cavities. In some cases, the rigid body 210 separates a first internal cavity 254 and a second internal cavity 252 by the inner flange 230. The first internal cavity 254 may house, at least in part, one or more crumb rubber isolators. The second internal cavity 252 may house, at least in part, one or more crumb rubber isolators.

The rigid body 210 may include an open first end 214. The rigid body 210 may also include an open second end 212. In at least some implementations, the rigid body may include a cylindrical wall therebetween. That is, the cylindrical wall may extend from the first open end 214 to the second open end 212. The cylindrical wall includes an interior and exterior surface. In some cases, the one or more crumb rubber isolators are also cylindrically shaped. In some cases, the interior of the cylindrical wall is adjacent to the crumb rubber isolators. That is, the cylindrical wall may house the crumb rubber isolators. The cylindrical wall may have an inner diameter corresponding to the outer diameter of the crumb rubber isolators.

In some implementations, the flange 220 may have a first open end and a second open end. The flange 220 may have a plurality of holes configured to receive a plurality of fasteners. In some cases, the flange 220 may be triangularly shaped. The triangularly flange 220 may have at least three through holes located near the corners thereof. In some cases, the second open end of the flange 220 may be configured to be mounted to a surface of a first structure using fasteners.

In some cases, the height of the housing 200 may be approximately between 2 and 3 inches. In some cases, the diameter of the first and second open end may be approximately 2 inches. In some cases, the depth of the upper internal cavity may be approximately 1.4 inches. In some cases, the depth of the lower internal cavity may be approximately 1 inch.

FIG. 3 illustrates a perspective view of an example of a crumb rubber isolator 300. In some cases, the crumb rubber isolator 300 is constructed of rebound crumb rubber. In some cases, the crumb rubber isolator 300 is constructed of recycled rebound crumb rubber. In some cases, the crumb rubber isolator 300 in constructed of bonded crumb rubber. In some implementations, the crumb rubber isolator may include various types or compositions of rubber.

The crumb rubber isolator may include different types of crumb rubber, such as, ambient crumb rubber, cryogenic crumb rubber, mesh crumb rubber, superfine crumb rubber, and colored crumb rubber. In some implementations, the crumb rubber isolator may consist of various sizes of crumb rubber, from 10 mesh to 200 mesh, such as, coarse crumb rubber, medium crumb rubber, fine crumb rubber and micronized crumb rubber. For example, different sizes of crumb rubber include 20 mesh (0.841 mm), 40 mesh (0.4 mm), 80 mesh (0.177 mm), and 100 mesh (0.149 mm).

The crumb rubber isolator may consist of different grades of crumb rubber, based on the different characteristics of the material, and based on the compression deflection rating.

The crumb rubber isolator may by made of GenieMat™ FFNP. By way of background, GenieMat™ FFNP is made of two ingredients, recycled post consumer car tires and a binder which is 94% recycled content. Further, the GenieMat™ FFNP is used for impact sound insulation.

In some cases, the crumb rubber isolator is made of soft crumb rubber which has properties with grade, size, and composition that are more shock absorbent, and flexible. For example, soft crumb rubber may refer to the characteristic of having a relatively low hardness or durometer. It may also refer to having a softer and more flexible characteristic compared to other rubber materials.

The crumb rubber isolator 300 may be shaped like a cylindrical washer. For example, it may be ring-shaped. In some cases, the crumb rubber isolator 300 may be shaped to be adjacent to the housing. In some cases, the crumb rubber isolator 300 is configured to be situated, at least in part, in the housing of the isolation mount.

A plurality of crumb rubber isolators 300 may be used in the isolation mount. The plurality of crumb isolators may be vertically stacked and/or adjacent. The plurality of crumb isolators may have a central hole or through hole which is configured for a fastener. In some cases, the edge of the through hole may be threaded.

In some implementations, the isolation material used in the isolator 300 may not be limited to merely crumb rubber but includes other types of rubber, for example, neoprene rubber.

In some cases, the diameter of the crumb rubber isolator may be approximately 2 inches. In some cases, the height may be 0.5 inches. In some cases, the diameter of the through hole may be approximately 0.5 inches.

In some cases, the crumb rubber isolator may be molded into any shape. In some cases, the isolation mount comprises of a flange, and a crumb rubber isolator body bonded to the flange and includes a central bore configured to receive a fastener. The crumb rubber isolator body and the flange may be bonded together by an adhesive. The crumb rubber isolator body may further include a threaded shaft configured to receive a fastener. The threaded shaft may be centrally displaced in the axis of rotation of the crumb rubber isolator body and bonded thereto by an adhesive.

As illustrated in FIG. 1, a plurality of crumb rubber isolators may be included in a single isolation mount 100. The plurality of crumb rubber isolators may be of a common size and shape. Conveniently, these crumb rubber isolators may be cut or otherwise formed from a mat. For example, the crumb rubber isolators may be die cut from a mat. In at least some implementations, the number of crumb rubber isolators included in the isolation mount may vary depending on desired operating parameters.

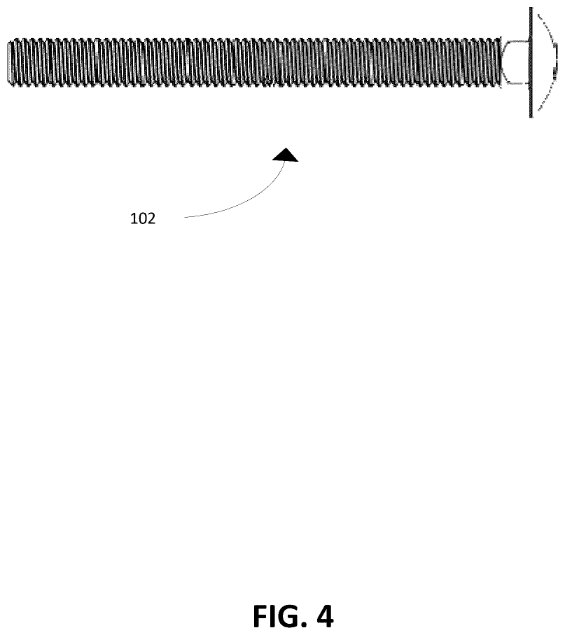

FIG. 4 illustrates an example of a fastener 102 which may be used in the isolation mount 100 in FIG. 1. The fastener 102 may be a bolt. For example, the fastener 102 may have a threaded shank, a head formed from the first end of the threaded shank and a second end in the opposing direction.

The fastener 102 may be configured to secure the housing of the isolation mount. For example, the fastener 102 may be configured such that it extends through the center of the isolation mount in the axial direction. In other words, the fastener 102 may be positioned along the central axis of the housing of isolation mount 100.

The head of the fastener 102 may interlock with a bottom washer. For example, the fastener may include a feature, such as a square portion, which is received in a square opening of the bottom washer 104. The interlocking of the fastener 102 and the bottom washer 104 prevents rotation of the fastener 102 relative to the bottom washer 104. Accordingly, when a rotational force is applied to the fastener, for example, during fastening using a nut, the fastener, the bottom washer, and the bottom isolator of a plurality of isolators, would impede this rotational force. That is, rotation of the nut will not cause rotation of the bolt or other fastener, which might impede fastening. In some implementations, the fastener 102 may be a carriage bolt. In some cases, the bolt may range from ⅜ to ⅝ inches.

In some implementations, an end of the fastener 102 may protrude out the top end of the isolation mount 100. In some cases, this end may be coupled to the second surface of an object, such as, an HVAC system.

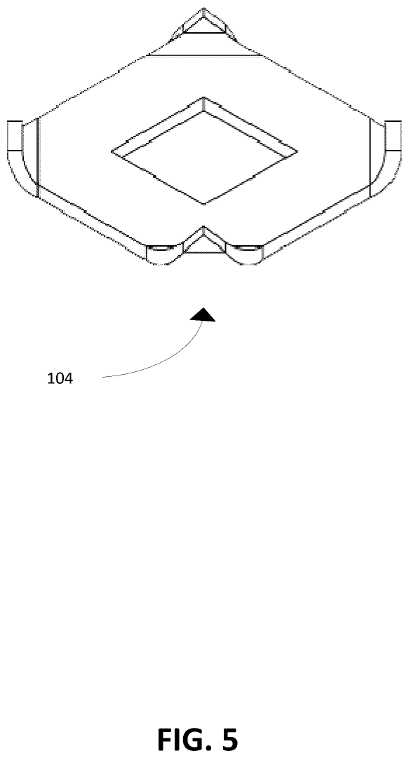

FIG. 5 illustrates a perspective view of an example of a bottom washer 104 which may be used in the isolation mount 100. In some cases, the bottom washer 104 may be a bolt lock washer. The bottom washer 104 may be configured to receive a bolt, and in particular, a long carriage bolt. As noted above, the bottom washer 104 interlocks with a head or other locking feature of a bolt. In some implementations, the bottom washer 104 may have protrusions facing up to grip the bottom crumb rubber isolator 112 (FIG. 1). In some cases, the bottom washer 104 may be square-shaped. The four corners of the square-shaped washer protrude upwards. The protrusions grip the bottom crumb rubber isolator 112. In some implementations, the bottom washer 104 may have a diameter of approximately 1.2 inches. The bottom washer is generally planar, with the exception of the protrusions which extend above the plane in order to grip the crumb rubber isolators.

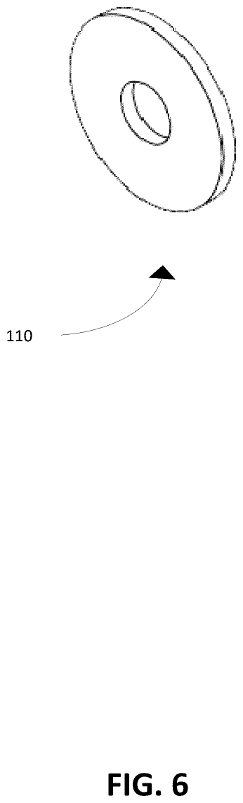

FIG. 6 illustrates a perspective view of an example of a top washer 110 which may be used in the isolation mount. The top washer 110 is located on top of the plurality of crumb rubber isolators 106 opposed from the bottom end of the isolation mount.

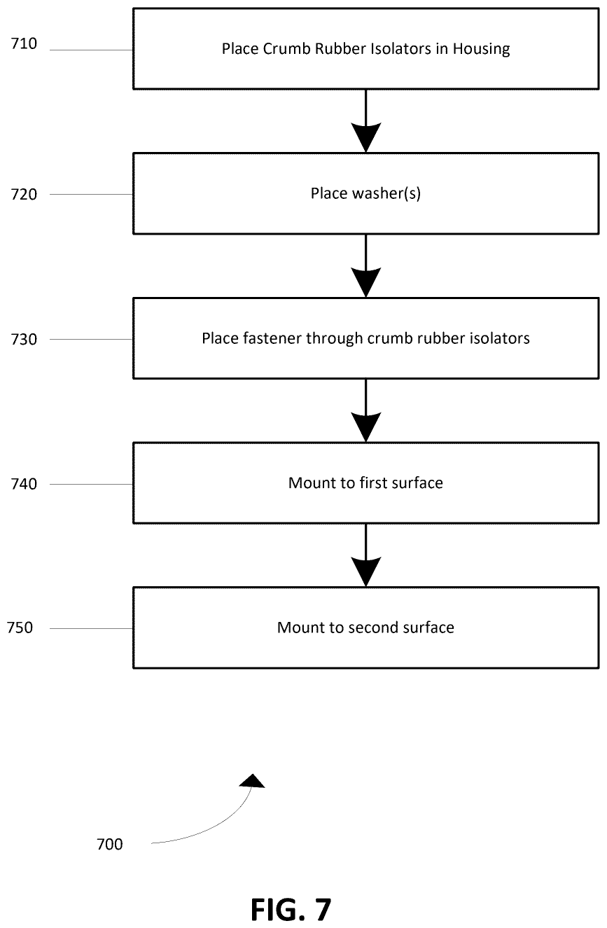

FIG. 7. Illustrates an example of a method 700 of installing the isolation mount 100. First, at a step 710, crumb rubber isolators 106 are placed within one or more cavities of a housing 108 of the isolation mount 100. The crumb rubber isolators 106 may be axially aligned within the housing 108. Put differently, a hole of each of the crumb rubber isolators may be aligned to allow a fastener 102, such as a bolt to pass therethrough.

In at least some implementations, at the step 710, a crumb rubber isolator 106 is placed in a first cavity 254. In at least some implementations, at the step 710, a plurality of crumb rubber isolators 106 are placed in a second cavity 252. In other implementations, a single crumb rubber isolator 106 may be placed in the second cavity 252.

Next, at a step 720, one or more washers may be placed on one or more ends of the crumb rubber isolators 106. For example, a top washer 110 may be placed at a top end and a bottom washer 104 may be placed at a bottom end.

Next, at a step 730, a fastener 102 may be placed through the crumb rubber isolators 106 and washers. The fastener 102 may be inserted from the bottom so that a locking feature associated with a head of the fastener 102 may lock or mate with a corresponding feature of the bottom washer 104.

Next, at a step 740, the isolation mount 100 may be mounted to a first surface. The first surface may be a wall, floor or ceiling. The isolation mount may be mounted to the first surface using a base fastener. The base fastener may be of the type described above. For example, in some implementations, the base fastener may be or include a screw or bolt that may fasten the isolation mount 100 using one or more holes in the housing 108.

Next, at a step 750, the isolation mount 100 may be mounted to a second surface. The second surface may be a surface associated with a vibration source. The isolation mount 100 may be mounted to the second surface using the fastener 102. For example, the fastener 102 may pass through a hole in the second surface and then attached to the second surface using a nut.

The above discussed embodiments are considered to be illustrative and not restrictive. Certain adaptations and modifications of the described embodiments may be made. All such modification, permutations and combinations are intended to fall within the scope of the present disclosure.

What is claimed is:

1. An isolation mount for reducing transmission of vibrations between a first surface and a second surface, comprising:
a housing including:
a rigid body defining a hole for receiving a fastener to couple the rigid body to the second surface;
a flange connected to the rigid body, the flange for coupling the isolation mount to the first surface; and
one or more crumb rubber isolators having through holes for receiving the fastener.

2. The isolation mount of claim 1, wherein the isolation mount includes the fastener for coupling the isolation mount to the second surface.

3. The isolation mount of claim 1, wherein the rigid body defines at least one internal cavity and wherein the one or more crumb rubber isolators are situated, at least in part, in at least one of the internal cavities.

4. The isolation mount of claim 1, wherein the crumb rubber isolators are constructed of rebound crumb rubber.

5. The isolation mount of claim 1, wherein the crumb rubber isolators are constructed of recycled rebound crumb rubber.

6. The isolation mount of claim 1, wherein the crumb rubber isolators are constructed of soft crumb rubber.

7. The isolation mount of claim 1, wherein the crumb rubber isolators are constructed of at least 94% recycled rubber content.

8. The isolation mount of claim 1, wherein the flange is triangularly shaped with a plurality of holes configured to allow the flange to be secured to the first surface.

9. The isolation mount of claim 1, further comprising a top washer disposed on a top surface of a top isolator of the one or more crumb rubber isolators.

10. The isolation mount of claim 1, further comprising a bottom washer disposed on a bottom surface of a bottom isolator of the one or more crumb rubber isolators.

11. The isolation mount of claim 10, wherein the bottom washer includes at least one protrusion to grip the bottom isolator.

12. The isolation mount of claim 11, wherein the fastener is a bolt, wherein the bolt includes a threaded shank between a first end and a second end, and wherein the first end has a head that interlocks with the bottom washer to prevent relative rotational movement between the bolt and the bottom washer.

13. The isolation mount of claim 1, wherein the rigid body of the housing has a substantially circumferential wall, and an inner flange extending from an interior side of the circumferential wall.

14. The isolation mount of claim 13, wherein the inner flange is placed between the one or more crumb rubbers isolators.

15. The isolation mount of claim 13, wherein the housing includes a threaded shaft running along a center of the housing, and wherein the one or more crumb rubber isolators supports the threaded shaft, and wherein the threaded shaft is configured to receive the fastener.

16. The isolation mount of claim 15, wherein an inner circumferential edge of the inner flange is connected to an exterior wall of the threaded shaft.

17. The isolation mount of claim 1, wherein the one or more crumb rubber isolators are cylindrically shaped.

18. The isolation mount of claim 1, wherein the one or more crumb rubber isolators are adjacent to an interior wall of the rigid body of the housing.

19. An isolation mount assembly for reducing transmission vibrations, comprising:
a first surface;
a second surface;
an isolation mount, comprising:
a fastener for coupling the isolation mount to the second surface;
a housing including:
a rigid body defining a hole for receiving the fastener;
a flange connected to the rigid body, the flange for coupling the isolation mount to the first surface; and
one or more crumb rubber isolators having through holes for receiving the fastener.
